(19) United States
(12) Patent Application Publication
(10) Pub. No.: US 2014/0074314 A1
(43) Pub. Date: Mar. 13, 2014

(54) STRUCTURED MEDIA AND METHODS FOR THERMAL ENERGY STORAGE

(71) Applicant: Saint-Gobain Ceramics & Plastics, Inc, Worcester, MA (US)

(72) Inventors: Hassan S. Niknafs, Stow, OH (US); Thomas Szymanski, Hudson, OH (US); Daniel C. Sherman, Hudson, OH (US)

(73) Assignee: Saint-Gobain Ceramics & Plastics, Inc, Worcester, MA (US)

(21) Appl. No.: 14/010,629

(22) Filed: Aug. 27, 2013

Related U.S. Application Data
(60) Provisional application No. 61/698,876, filed on Sep. 10, 2012.

(51) Int. Cl. G05D 23/19

(52) U.S. Cl. CPC G05D 23/19
USPC 700/300

(57) ABSTRACT

Thermal energy storage articles, systems, and methods for making and using such thermal energy storage articles and systems. A thermal energy storage zone comprising: a first plurality of flow paths; a second plurality of flow paths; and a bed of heat storage media comprising a plurality of structured heat storage elements and a plurality of random heat storage media, wherein the first and second plurality of flow paths pass through a common container, wherein the first plurality of flow paths are configured to extend through the plurality of structured heat storage elements and the second plurality of flow paths are configured to extend through the random heat storage media, and wherein the first plurality of flow paths and the second plurality of flow paths do not intersect within the bed of heat storage media.

### CROSS-REFERENCE TO RELATED APPLICATION

This application claims the benefit of U.S. Provisional Application No. 61/698,876 filed Sep. 10, 2012.

### BACKGROUND

1. Field of the Disclosure

The present disclosure is generally directed to thermal energy storage articles, systems, and methods for making and using such thermal energy storage articles and systems.

2. Description of the Related Art

Thermal energy storage of all types plays an important role in energy conservation. The efficient collection, use, and conservation of thermal energy, such as solar energy or waste heat from industrial processes, are an important aspect of energy development and energy management. In particular, storage of thermal energy in the form of sensible and latent heat is important.

There has been intense interest in the ability to efficiently store and retrieve large amounts of thermal energy (i.e., heat energy). Thermal storage technology exists that can recover, store, and withdraw heat energy, including natural energy such as solar thermal energy, terrestrial heat (e.g., volcanic, hydrothermal, etc.), and artificially produced heat energy such as industrially generated waste heat. Thermal energy storage systems can be broadly classified into sensible heat systems, latent heat systems, and bond energy systems. Sensible heat systems are those which store thermal energy by heating a medium, typically a liquid or a solid, without any change of phase. Latent heat systems are those which heat a medium that undergoes a phase change (usually melting). Bond energy storage systems are those which store thermal energy by having a medium undergo an endothermic-exothermic reaction that converts the thermal energy into chemical energy.

Thermal energy storage improves performance of energy systems by smoothing supply and increasing reliability. Although solar energy is an abundant, clean, and safe source of energy, it suffers from yearly and diurnal cycles; thus necessarily being intermittent, and often is unpredictable and diffused due to variable weather conditions (e.g., rain, fog, dust, haze, cloudiness). Further, the demand for energy is also unsteady; following yearly and diurnal cycles for both industrial and consumer needs.

Additionally, thermal energy storage systems, particularly sensible thermal energy storage systems, typically include massive thermal energy storage zones that present numerous construction challenges, including how to quickly and efficiently construct such thermal energy storage zones as part of a thermal energy storage system. Therefore, there continues to be a demand for improved, cost effective articles, processes, and systems that promote efficient storage, recovery, and usage of thermal energy.

### BRIEF DESCRIPTION OF THE EMBODIMENTS

In an embodiment, a thermal energy zone comprises: a first plurality of flow paths; and a second plurality of flow paths, wherein the first and second plurality of flow paths pass through a common container, and wherein the first plurality of flow paths and the second plurality of flow paths do not intersect, and wherein the first plurality of flow paths are substantially linear and the second plurality of flow paths are tortuous and wherein the first plurality of flow paths are configured to extend through a plurality of structured heat storage elements and the second plurality of flow paths are configured to extend through random media.

The first plurality of flow paths can periodically merge into a single flow path that later rebranches into a plurality of flow paths. The first plurality of flow paths can be separated from the second plurality of flow paths by a continuous wall. The first plurality of flow paths can pass through at least a first inner container disposed within the common container. The first plurality of flow paths can pass through a plurality of inner containers disposed within the common container.

The first and second plurality of flow paths can share a common inlet region and a common outlet region.

In another embodiment, the thermal energy zone can further comprise a thermal energy transfer fluid. The thermal energy storage zone can have a pressure drop measured across the first plurality of flow paths (PDrop1) and a pressure drop measured across the second plurality of flow paths (PDrop2) such that the ratio of PDrop1 to PDrop2 is in a range from 1:0.7 to 1:1. The fluid flow through the first plurality of flow paths can be laminar, turbulent, or combinations thereof. The fluid flow through the second plurality of flow paths can be laminar, turbulent, or combinations thereof.

In an embodiment, a thermal energy storage zone comprises: an outer container; a plurality of structured heat transfer elements; and a plurality of random media, wherein the structured heat storage elements and the plurality of random heat storage media are disposed within the outer container.

In another embodiment, a thermal energy storage zone can further comprise: at least a first inner container; wherein the at least first inner container is disposed within the outer container, and wherein the plurality of structured heat storage elements are disposed within the at least first inner container, and wherein the plurality of random heat storage media are disposed within the outer container and outside of the at least first inner container.

In another embodiment, a thermal energy storage zone can comprise a plurality of inner containers disposed within the outer container, wherein the plurality of structured heat storage elements are disposed within the plurality of inner containers, and wherein the plurality of random heat storage media are disposed within the outer container and outside of the plurality of inner containers. The random heat storage media can be disposed between the plurality of inner containers.

The thermal energy storage zone can further comprise an open cavity disposed between each of the plurality of structured heat transfer elements.

The thermal energy storage zone can have a pressure drop measured across the plurality of random heat storage media (PDrop_{random}) and a pressure drop measured across the plurality of structured heat storage elements (PDrop_{structured}) having a percent difference of 25% or less. The pressure drop measured across the plurality of random heat storage media (PDrop_{random}) can be greater than or equal to a pressure drop measured across the plurality of structured heat storage elements (PDrop_{structured}). The pressure drop measured across the plurality of random heat storage media (PDrop_{random}) and a pressure drop measured across the plurality of structured heat storage elements (PDrop_{structured}) is such that the ratio of PDrop_{random} to PDrop_{structured} is in a range from about 10:1 to about 1:1.

In an embodiment, the dimensions of the structured heat storage elements can define the space of the thermal energy storage zone. The thermal energy storage zone can have a height or length equal to the total height or length of the structured heat transfer elements. The thermal energy storage zone can have a height that is at least 50% of the height of the outer container.

In an embodiment, each of the plurality of the structured heat storage elements can have a void fraction (Vfₛ) and the plurality of random heat storage media can have a unit volume void fraction (Vfᵣ), such that the ratio of Vfᵣ to Vfₛ is in a range from 2:1 to 1:1.

In an embodiment, each of the plurality of structured heat storage elements can have a void fraction of 38% or less.

The plurality of structured heat storage elements can be configured to conform to the inner dimensions of the outer container, the at least first inner container, or each of the plurality of inner containers. The plurality of structured heat storage elements can be arranged vertically or horizontally within the outer container, the at least first inner container, or each of the plurality of inner containers. Each of the structured heat storage elements can be comprised of one or more different materials, including a ceramic material.

The random heat storage media can have a void fraction per unit volume in a range of 0.2 to 0.4. The random heat storage media can be disposed between an inner surface of the outer container and the structured heat transfer element. The random heat storage media can be disposed between an inner surface of the outer container and an outer surface of the at least first inner container.

In another embodiment the random heat storage media can be disposed between an inner surface of the outer container and an outer surface of each of the plurality of inner containers. The random heat storage media can be arranged around the inner containers.

The random heat storage media can be comprised of the same or different materials of construction as the structured heat transfer elements.

In an embodiment, the outer container has an inlet and an outlet. The outer container can be configured to hold the at least first inner container, or a plurality of inner containers, in an orientation selected from the group consisting of: horizontal, vertical, slanted, or combinations thereof. The outer container can be a pressure vessel or containment vessel, such as a tank, a pipe, a reactor, a column, a tower, and the like.

In an embodiment, the at least first inner container, or a plurality of inner containers can have an inlet and an outlet. The at least first inner container, or each of the plurality of inner containers, can have a height equal to from about 50% to about 150% of the total height of the plurality of structured heat storage elements disposed therein. The plurality of inner containers can be arranged in a pattern within the outer container. The plurality of inner containers can have a cross-sectional shape selected from the group consisting of: circular, triangular, quadrilateral, pentagonal, hexagonal, heptagonal, octagonal, and combinations thereof. The at least first inner container can be a tube.

### BRIEF DESCRIPTION OF THE DRAWINGS

The present disclosure may be better understood, and its numerous features and advantages made apparent to those skilled in the art by referencing the accompanying drawings.

FIG. 1A is an illustration of an embodiment of a thermal energy storage zone showing fluid flow paths extending through a bed of heat storage media comprised of rectangular structured heat storage media that is surrounded by random heat storage media.

FIG. 1B is an illustration of a top view of the same embodiment of a thermal energy storage zone displayed in FIG. 1A.

FIG. 2A is an illustration of an embodiment of a thermal energy storage zone showing fluid flow paths extending through a bed of heat storage media comprised of rectangular structured heat storage media disposed within an inner container and the inner container is surrounded by random heat storage media.

FIG. 2B is an illustration of a top view of the same embodiment of a thermal energy storage zone displayed in FIG. 2A.

FIG. 3A is an illustration of an embodiment of a thermal energy storage zone showing fluid flow paths extending through a bed of heat storage media comprised of cylindrical structured heat storage media disposed within a plurality of inner containers that are surrounded by random heat storage media.

FIG. 3B is an illustration of a top view of the same embodiment of a thermal energy storage zone displayed in FIG. 3A.

FIG. 4 is an illustration of an embodiment of a rectangular structured heat storage element (heat storage block) having an integral lip.

FIG. 5 is an illustration of an exploded view of an embodiment of two rectangular structured heat storage blocks separated by a rectangular spacer ring.

FIG. 6 is an illustration of an embodiment of a thermal energy storage zone showing fluid flow paths extending through a bed of heat storage media comprised of cylindrical structured heat storage blocks disposed within a plurality of tubes that are arranged within a storage tank and that are surrounded by random heat storage media.

The use of the same reference symbols in different drawings indicates similar or identical items.

### DETAILED DESCRIPTION OF THE EMBODIMENT(S)

The following description, in combination with the figures, is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

Embodiments are described herein that are directed to a thermal energy storage zone that can be used in large scale thermal energy storage apparatus, such as those associated with solar powered energy generators. Particular embodiments are directed to thermal energy storage zones that include thermal energy storage media. The thermal energy storage media can be structured thermal energy storage media, random thermal energy storage media, or combinations thereof. Structured thermal energy storage media, may also be referred to herein as structured heat storage media, structured heat storage elements, or structured heat storage blocks. In an embodiment, the thermal energy storage media can be a bed of thermal energy storage media comprised of random thermal energy storage media in combination with structured thermal energy storage media. The structured thermal energy storage media, or the random thermal energy storage media, or combinations thereof, can be disposed within a container, such as a large containment vessel, tank, or pipe. A heat transfer fluid that has been charged with thermal energy (i.e., heated), such as by exposure to the sun or other heat source, can be made to flow over and through the thermal energy storage media of the thermal energy storage zone. The thermal energy storage media in turn absorbs heat from the hot heat transfer fluid and stores the absorbed thermal energy for later use, such as during periods when a solar powered collector cannot provide a sufficient quantity of hot fluid directly to a generator (e.g., at night). During such conditions, heat transfer fluid can be flowed through the hot thermal energy storage media so that the heat transfer fluid absorbs the stored thermal energy, which can then be transferred to the generator where it can be used, for example, to generate steam. It will be appreciated that a thermal energy storage zone for use in applications requiring high heat capacity and long cycle times, such as in a solar power generator, an advanced adiabatic compressed air energy storage system, a geothermal energy system, and the like, will have notable different characteristics, such as length of cycle time (i.e., time for full charge and discharge of stored heat), total amount of storage mass, amount of heat storage per unit mass per unit time, and others characteristics compared to other thermal energy transfer zones encountered in the art. For instance, a regenerative thermal oxidizer (“RTO”) is characterized by having much shorter cycle times (minutes compared to hours) and much lower total heat capacity.

Embodiments are described herein that are directed to a thermal energy storage zone. Particular embodiments comprise groupings of flow paths, while other particular embodiments comprise certain structures for creating and manipulating such groupings of flow paths. Other particular embodiments are directed to methods for constructing a thermal energy storage zone. As described in greater detail below, a thermal energy storage zone can comprise structured heat storage media and random heat storage media. The structured heat storage media and random heat storage media can be arranged in a bed. The structured heat storage media and the random heat storage media can be arranged so that they are in substantially parallel alignment with each other within the bed. The structured heat storage media and the random heat storage media can be arranged so that they are substantially aligned with the direction of fluid flow through the thermal energy transfer zone. The structured heat storage media has a low open face area and a low void fraction. The random heat storage media can be arranged in one or more portions of the bed, or in separate beds that surround the structured heat transfer media. The flow paths through the structured heat storage media and the random heat storage media can be arranged so that they do not intersect within the bed of thermal energy storage media (i.e., the flow paths) do not intersect within the thermal energy transfer zone.

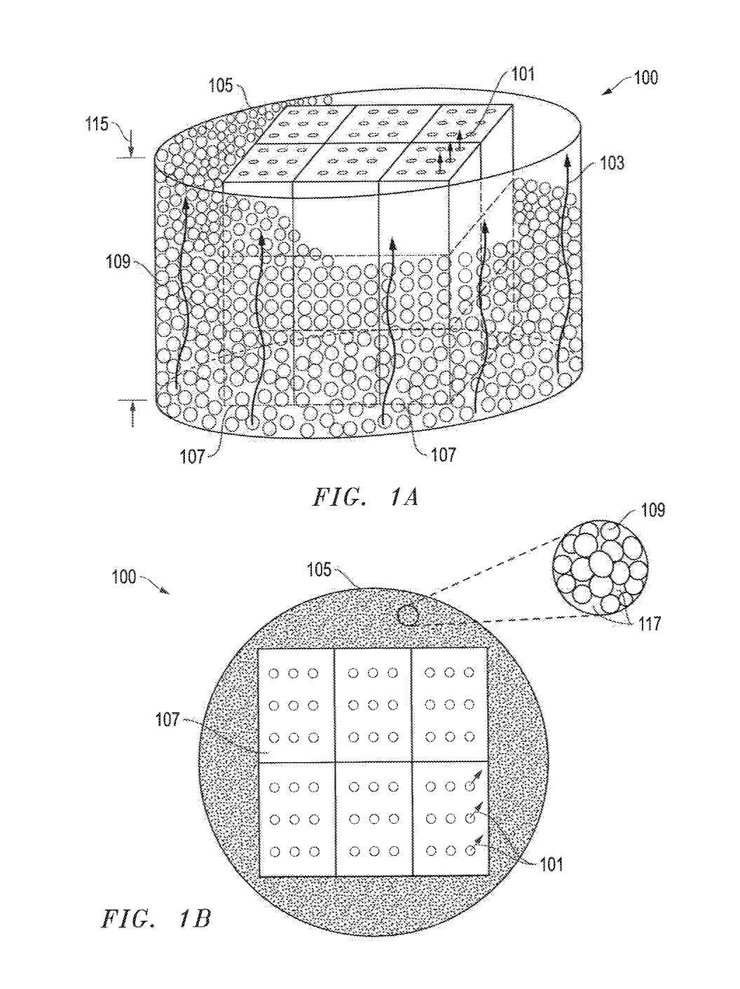

In an embodiment, shown in FIGS. 1A and 1B, a thermal energy storage zone 100 comprises a first plurality of flow paths 101 and a second plurality of flow paths 103, wherein the first and second plurality of flow paths pass through a common container 105. The first plurality of flow paths are configured to extend through a plurality of structured heat storage elements 107 and the second plurality of flow paths are configured to extend through a plurality of random heat storage media 109. The structured heat storage elements and the random heat storage media form a bed. The container can be filed with random heat storage media up to the same height as the structured heat transfer elements. The height 115 of the structured heat transfer elements defines the height of the thermal energy storage zone. The first plurality of flow paths and the second plurality of flow paths do not intersect within the bed of thermal energy storage media. The first plurality of flow paths are substantially linear and the second plurality of flow paths are tortuous. The second plurality of flow paths can coincide with, or be commensurate with, the network of open spaces 117 that exist between the random heat storage media.

A thermal energy storage zone can be defined by a plurality of flow paths that pass through a common container. The flow paths can be influenced and directed by the shape and dimensions of the interior surface of the common container, as well as the shape and dimensions of any other objects that might be disposed within the common container. The flow paths of the plurality of flow paths can be the same or different, and the flow paths can be divided into multiple groups, i.e., multiple pluralities of flow paths, based on certain desired flow path characteristics, such as the location of the flow paths within the thermal energy storage zone, the shape of the flow paths, whether the flow paths extend through thermal energy storage media or other objects, the fluid flow rate along the flow paths, the fluid flow type along the flow paths, whether the fluid flow paths will intersect or will be separate from each other, or combinations thereof. The number of pluralities of flow paths can be varied as desired.

In an embodiment, the thermal energy storage zone can comprise at least a first and second plurality of flow paths. In another embodiment, the first plurality of flow paths can be substantially linear as it extends within, or through, a common container. The first plurality of flow paths can intersect with, or be separate from any number of other pluralities of flow paths that extend through the common container. The first plurality of flow paths can periodically merge into a single flow path that later rebranches back into a plurality of flow paths. The first plurality of flow paths can be substantially vertical, substantially horizontal, or combinations thereof, as it extends through the common container of the thermal energy storage zone.

In an embodiment the first plurality of flow paths extends through a plurality of structured thermal energy storage elements, which are described in greater detail below. The first plurality of flow paths can periodically merge into a single flow path that later rebranches back into a plurality of flow paths. The first plurality of flow paths can be substantially vertical, substantially horizontal, or combinations thereof, as it extends through the structured thermal energy storage elements.

In an embodiment, the first plurality of flow paths can be separated partially, intermittently, or fully from a second plurality of flow paths. Conversely, the first plurality of flow paths can be directed to intersect, merge, or mix with a second plurality of fluid flow paths. In an embodiment, the first plurality of flow paths is separated from a second plurality of flow paths by a continuous barrier as the first plurality of flow paths extends through the common container of the thermal energy zone.

As previously stated, multiple pluralities of flow paths can be present and extend through the common container. In an embodiment, at least a second plurality of flow paths extends through the common container. In an embodiment, the second plurality of flow paths is tortuous. The second plurality of flow paths can be in fluid communication with each other or be discrete from each other.

In an embodiment, the second plurality of flow paths extends through a plurality of random thermal energy transfer elements, which are described in greater detail below.

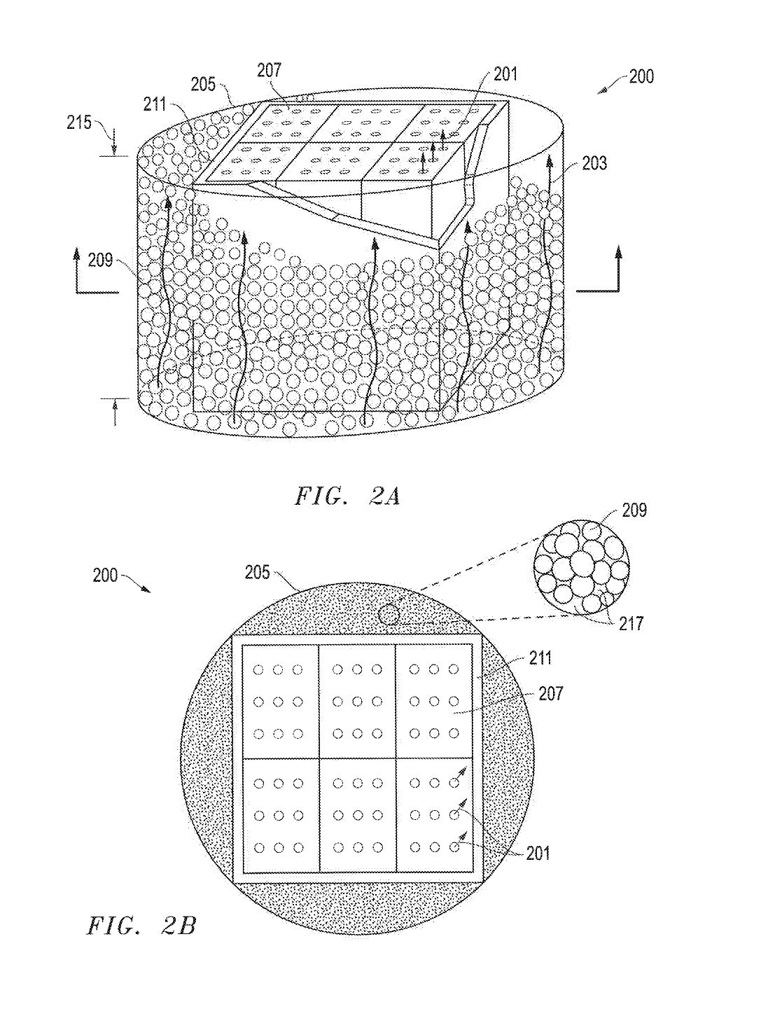

In an embodiment, shown in FIGS. 2A and 2B, a thermal energy storage zone 200 comprises a first plurality of flow paths 201 and a second plurality of flow paths 203, wherein the first and second plurality of flow paths pass through a common container 205. The first plurality of flow paths are configured to extend through a plurality of structured heat storage elements 207 that are disposed within a second container 211, which is disposed within the common container. The second plurality of flow paths are configured to extend through a plurality of random heat storage media 209. The structured heat storage elements and the random heat storage media form a bed. The common container can be filed with random heat storage media up to the same height as the structured heat transfer elements. The height 215 of the structured heat transfer elements defines the height of the thermal energy storage zone. The first plurality of flow paths and the second plurality of flow paths do not intersect within the bed of thermal energy storage media. The first plurality of flow paths are substantially linear and the second plurality of flow paths are tortuous. The second plurality of flow paths can coincide with, or be commensurate with, the network of open spaces 217 that exist between the random heat storage media.

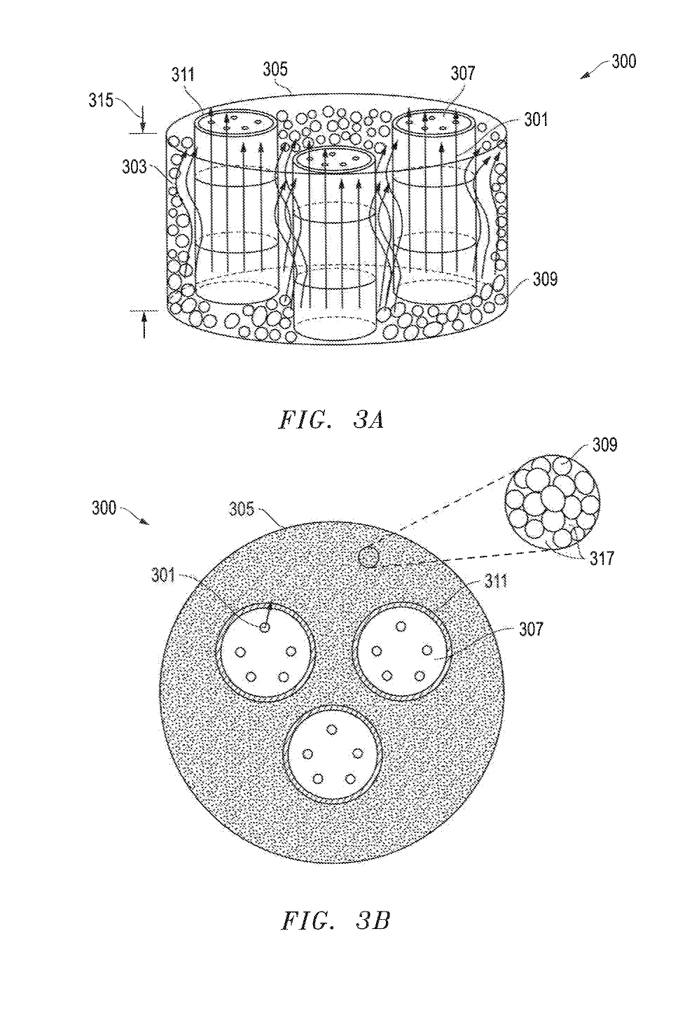

In an embodiment, shown in FIGS. 3A and 3B, a thermal energy storage zone 300 comprises a first plurality of flow paths 301 and a second plurality of flow paths 303, wherein the first and second plurality of flow paths pass through a common container 305. The first plurality of flow paths are configured to extend through a plurality of structured heat storage elements 307 that are disposed within a plurality of inner containers 311 that are disposed within the common container. The second plurality of flow paths are configured to extend through a plurality of random heat storage media 309. The structured heat storage elements and the random heat storage media form a bed. The common container can be filled with random heat storage media up to the same height as the structured heat transfer elements. The height 315 of the structured heat transfer elements defines the height of the thermal energy storage zone. The first plurality of flow paths and the second plurality of flow paths do not intersect within the bed of thermal energy storage media. The first plurality of flow paths are substantially linear and the second plurality of flow paths are tortuous. The second plurality of flow paths can coincide with, or be commensurate with, the network of open spaces 317 that exist between the random heat storage media.

The thermal energy storage zone comprises a common container through which the pluralities of flow paths extend. The common container can be configured to enclose, envelope, hold, and/or channel a large number of flow paths, as well as different types of flow paths. The common container can be configured to contain one or more inner containers. The common container can also be called an outer container depending on whether there is an at least first inner container or a plurality of inner containers disposed within the common container. The common container can have a single inlet and outlet, a plurality of inlets and outlets, or combinations thereof. In an embodiment, a first and second plurality of flow paths pass through a common container. In an embodiment, the common container, also called an outer container, can be configured to hold at least a first inner container, or a plurality of inner containers, in an orientation selected from the group consisting of: horizontal, vertical, slanted, or combinations thereof. The plurality of inner containers can be arranged randomly, according to a regular pattern, or a combination thereof within the common container. In an embodiment, the plurality of inner containers can be in pattern having the shape of regular polygons, irregular polygons, ellipsoids, circles, arcs, crosses, spirals, channels, or combinations thereof. In another embodiment, the pattern of the inner containers can include: an array of vertical, diagonal, or horizontal rows and columns; a radial pattern, a spiral pattern, a phyllotactic pattern, a symmetric pattern, an asymmetric pattern, or combinations thereof. The common container can be a pressure vessel or containment vessel, such as a tank, a reactor, a column, a tower, a pipe, and the like. The common container can be formed from any material that provides sufficient structural strength and that is compatible with an intended heat transfer fluid, as well as, any other chemicals, compounds, or other materials that will be in contact with the common container. In an embodiment, the common container can be formed from metal material, ceramic material, cermet material, vitreous material, polymer material, composite material, or combinations thereof. In an embodiment, the metal material can be iron, cast iron, carbon steel, alloy steel, stainless steel, or combinations thereof. Common containers are large structures and typically have a volume in a range of about 10 m³ to about 100,000 m³; however, volumes that are smaller or larger can also be used.

The present embodiments of structured heat storage elements are not to be confused with “structured” packing media for mass transfer operations. Instead, the present embodiments function to absorb a large amount of thermal energy over an extended period of time, to retain the thermal energy for extended periods of time, and when desired, release the absorbed thermal energy over a prolonged period of time. Such characteristics make the present embodiments particularly useful for inclusion in solar energy storage systems, advanced adiabatic compressed air energy storage systems, geothermal energy systems, and the like.

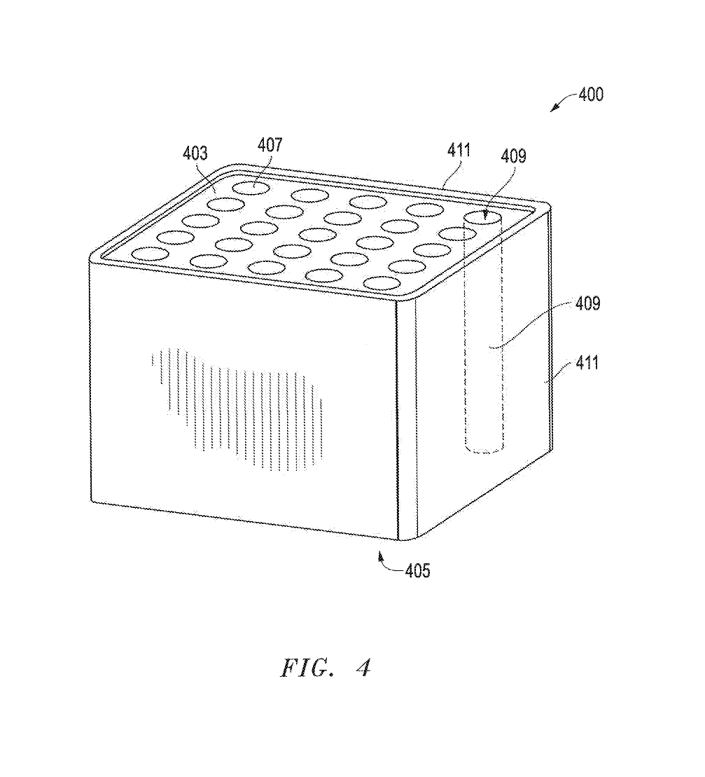

In an embodiment, as shown in FIG. 4, a structured heat storage element 400 includes a top surface 403, a bottom surface 405, and a plurality of perforations 407 that form passages 409 extending through the structured heat storage element from the top surface to the bottom surface. The structured heat storage element (structured heat storage block) has a void volume in a range of about 10% to about 35% and a mixing cavity-creating element 411 in the form of an integral lip.

The thermal energy storage properties of the thermal energy storage zone can be influenced by the shape and dimensions of the structured heat transfer media. The structured heat storage media can have notable shapes and dimensions of length, width, and height. The structured heat storage media of the thermal energy storage zone can be any shape that has a top surface and a bottom surface and that has overall dimensions that allow it to fit within the common container; or within an at least second container or within a plurality of containers (inner containers), if such at least second container or plurality of containers are disposed within the common container. In an embodiment, the structured heat storage media can have smaller dimensions than the interior dimensions of the common container, such that multiple blocks of thermal energy storage media can be arranged vertically and side by side to fit within the common container. In another embodiment, the length and width of the structured heat storage media are sized to be substantially equal to the interior length and width of the at least first inner container or the plurality of inner containers.

In an embodiment, the structured heat storage media can be unitary blocks. FIG. 4 illustrates a rectangular prism shaped block. In another embodiment, the structured heat storage media can comprise a plurality of pieces that fit together to form the structured heat transfer media, wherein the plurality of pieces can comprise a single column or a single layer of structured heat transfer media.

In an embodiment, the structured heat storage media can have a length dimension in a range of not greater than about 1.5 m (60 inches), such as a length not greater than about 1.2 m (48 inches), not greater than about 0.91 m (36 inches), not greater than about 0.61 m (24 inches), not greater than about 0.51 m (20 inches), not greater than about 0.46 m (18 inches), not greater than about 0.3 m (12 inches), not greater than about 0.25 m (10 inches), not greater than about 0.2 m (8 inches), or not greater than about 0.15 m (6 inches). In an embodiment, the length dimension can be not less than about 0.05 (2 inches), not less than about 0.08 m (3 inches), not less than about 0.10 m (4 inches), or not less than about 0.13 m (5 inches). The length dimension can be within a range comprising any pair of the previous upper and lower limits. In a particular embodiment, the length dimension can be in the range of not less than about 0.10 m (4 inches) to not greater than about 0.3 m (12 inches), such as not less than about 0.13 m (5 inches) to not greater than about 0.25 m (10 inches).

In an embodiment, the structured heat storage media can have a width dimension in a range of not greater than about 1.5 m (60 inches), such as a width not greater than about 1.2 m (48 inches), not greater than about 0.91 m (36 inches), not greater than about 0.61 m (24 inches), not greater than about 0.51 m (20 inches), not greater than about 0.46 m (18 inches), not greater than about 0.3 m (12 inches), not greater than about 0.25 m (10 inches), not greater than about 0.2 m (8 inches), or not greater than about 0.15 m (6 inches). In an embodiment, the width dimension can be not less than about 0.05 (2 inches), not less than about 0.08 m (3 inches), not less than about 0.10 m (4 inches), or not less than about 0.13 m (5 inches). The width dimension can be within a range comprising any pair of the previous upper and lower limits. In a particular embodiment, the width dimension can be in the range of not less than about 0.10 m (4 inches) to not greater than about 0.3 m (12 inches), such as not less than about 0.13 m (5 inches) to not greater than about 0.25 m (10 inches).

In an embodiment, the structured heat storage media can have a height dimension in a range of not greater than about 1.5 m (60 inches), such as a height not greater than about 1.2 m (48 inches), not greater than about 0.91 m (36 inches), not greater than about 0.61 m (24 inches), not greater than about 0.51 m (20 inches), not greater than about 0.46 m (18 inches), not greater than about 0.3 m (12 inches), not greater than about 0.25 m (10 inches), not greater than about 0.2 m (8 inches), or not greater than about 0.15 m (6 inches). In an embodiment, the height dimension can be not less than about 0.05 (2 inches), not less than about 0.08 m (3 inches), not less than about 0.10 m (4 inches), or not less than about 0.13 m (5 inches). The height dimension can be within a range comprising any pair of the previous upper and lower limits. In a particular embodiment, the height dimension can be in the range of not less than about 0.10 m (4 inches) to not greater than about 0.3 m (12 inches), such as not less than about 0.13 m (5 inches) to not greater than about 0.25 m (10 inches).

In a particular embodiment, the dimensions of length, width, and height are 0.15 m (6 inches) by 0.15 m (6 inches) by 0.3 m (12 inches) (6″×6″×12″).

The thermal energy storage properties of the thermal energy storage zone can be influenced by the open face area and the void volume of the structured heat transfer media. The open face area of the top surface or bottom surface of the structured heat storage media can be defined by a plurality of perforations on the top and bottom surface of the structured heat transfer media. Similarly, the void volume of the structured heat storage media can be defined by the passages that pass through the structured heat transfer media. In an embodiment, the open face area of the top or bottom surface of the structured heat storage media is in a range of not greater than about 38%, such as not greater than about 37%, not greater than about 36%, or not greater than about 35%. In an embodiment, the open face area of the top or bottom surface of the structured heat storage media can be in a range of not less than about 7%, such as not less than about 8%, not less than about 9%, or not less than about 10%. The open face area of the top or bottom surface of the structured heat storage media can be can be within a range comprising any pair of the previous upper and lower limits. In a particular embodiment, the open face area of the top or bottom surface of the structured heat storage media can be in a range of not less than about 10% to not greater than about 35%.

Similar to the open face area, in an embodiment, the void volume of the structured heat storage media can be in a range of not greater than about 38%, such as not greater than about 37%, not greater than about 36%, or not greater than about 35%. In an embodiment, the void volume of the structured heat storage media can be in a range of not less than about 7%, such as not less than about 8%, not less than about 9%, or not less than about 10%. The void volume of the structured heat storage media can be can be within a range comprising any pair of the previous upper and lower limits. In a particular embodiment, the void volume of the structured heat storage media can be in a range of not less than about 10% to not greater than about 35%.

The void volume, also called void fraction, of the structured heat storage media can be influenced by the size, shape, and arrangement of perforations (also called apertures, holes, openings, or voids) that are located on the top and bottom surfaces of the structured heat transfer media. The shape of the perforations can be regular or irregular. In an embodiment, the shape of the perforations can be in the form of slits, regular polygons, irregular polygons, ellipsoids, circles, arcs, crosses, spirals, channels, or combinations thereof. In a particular embodiment, the perforations have the shape of a circle. In another embodiment, the shape of the perforation can be in the form of one or more slits, wherein multiple slits can intersect, such as in the form of a cross or star. In another embodiment, the perforations are arcurate shaped.

The concentration of the perforations on the top and bottom surfaces of the structured heat storage media can be uniform or irregular. In an embodiment, the top or bottom surface of a structured heat storage media block can have a concentration of perforations in a range of not greater than about 7750 perforations per square meter (5 perforations per square inch), such as not greater than about 6200 perforations per square meter (4 perforations per square inch), not greater than about 4650 perforations per square meter (3 perforations per square inch), not greater than about 3875 perforations per square meter (2.5 perforations per square inch), not greater than about 3410 perforations per square meter (2.2 perforations per square inch), not greater than about 3100 perforations per square meter (2.0 perforations per square inch), not greater than about 2945 perforations per square meter (1.9 perforations per square inch), not greater than about 2790 perforations per square meter (1.8 perforations per square inch), or not greater than about 2635 perforations per square meter (1.7 perforations per square inch). In an embodiment, the top or bottom surface of a structured heat storage media can have a concentration of perforations in a range of not less than about 387.5 perforations per square meter (0.25 perforations per square inch), such as not less than about 775 perforations per square meter (0.5 perforations per square inch), not less than about 1240 perforations per square meter (0.8 perforations per square inch), or not less than about 1550 perforations per square meter (1.0 perforations per square inch). The concentration of perforations can be within a range comprising any pair of the previous upper and lower limits. In a particular embodiment, the concentration of perforations can be in the range of not less than about 775 perforations per square meter (0.5 perforations per square inch) to not greater than about 4650 perforations per square meter (3.0 perforations per square inch), such as not less than about 1550 perforations per square meter (1.0 perforation per square inch) to not greater than about 3100 perforations per square meter (2.0 perforations per square inch).

The perforations of the structured heat storage media have a notable hydraulic diameter. The hydraulic diameter can be useful to characterize certain dimensional and structural features of the embodiments of the structured heat storage media of the thermal energy storage zone. The hydraulic diameter of the individual perforations can be uniform or varying, the same or different. In an embodiment, the average hydraulic diameter of the perforations can be in a range of not greater than about 5.1 cm (2.0 inches), such as not greater than about 4.6 cm (1.8 inches), not greater than about 4.1 cm (1.6 inches), not greater than about 3.6 cm (1.4 inches), not greater than about 3.0 cm (1.2 inches), or not greater than about 2.5 cm (1.0 inches), not greater than about 2.3 cm (0.9 inches). In an embodiment, the average hydraulic diameter of the perforations can be in a range of not less than about 0.25 cm (0.1 inches), such as not less than about 0.51 cm (0.2 inches), or not less than about 0.76 cm (0.3 inches). The hydraulic diameter can be within a range comprising any pair of the previous upper and lower limits. In a particular embodiment, the hydraulic diameter can be in a range of not less than about 0.25 cm (0.1 inches) to not greater than about 5.1 cm (2.0 inches), such as not less than about 0.89 cm (0.35 inches) to not greater than about 2.5 cm (1.0 inches).

The spacing between adjacent perforations (i.e., the wall thickness) on the surface of the structured heat storage media is notable and can be useful, alone or in conjunction with the hydraulic diameter of the perforations, to characterize certain dimensional and structural features of the structured heat storage media of the thermal energy storage zone. The wall thickness between the individual perforations can be uniform or varying, the same or different. In an embodiment, the average ratio of hydraulic diameter to minimum wall thickness (D_{Havg}/Thk) can be in a range of not greater than about 3.0, such as not greater than about 2.8, not greater than about 2.6, not greater than about 2.4, not greater than about 2.2, not greater than about 2.0, or not greater than about 1.9. In an embodiment, the average ratio of hydraulic diameter to minimum wall thickness (D_{H}/Thk) can be in a range of not less than about 0.3, such as not less than about 0.4, or not less than about 0.5. The average ratio of hydraulic diameter to minimum wall thickness (D_{Havg}/Thk) can be within a range comprising any pair of the previous upper and lower limits. In a particular embodiment, the average ratio of hydraulic diameter to minimum wall thickness (D_{H}/Thk) can be in a range of not less than about 0.5 to not greater than about 3.0.

The perforations on the top or bottom surface of a structured heat storage media block can be arranged arbitrarily (e.g. randomly), or deliberately, in a myriad of patterns. The pattern of the perforations on the top surface can be the same or different as the pattern on the bottom surface. In an embodiment, a pattern of perforations can be any pattern having a uniform distribution, a non-uniform distribution, or a controlled non-uniform distribution. In another embodiment, a pattern of perforations can include: an array of vertical, diagonal, or horizontal rows and columns; a radial pattern, a spiral pattern, a phyllotactic pattern, a symmetric pattern, an asymmetric pattern, or combinations thereof. The pattern can cover (i.e., be distributed over) the entire top or bottom surface of the structured heat transfer media, can cover substantially the entire top or bottom surface of the structured heat storage media (i.e. greater than 50% but less than 100%), can cover multiple portions of the top or bottom surface of the structured heat transfer media, or can cover only a portion of the top or bottom surface of the structured heat transfer media.

The perforations on the top and bottom surfaces of the structured heat storage media can define the shape of the passages that extend through the structured heat transfer media. The cross-sectional shape of the passages can be the same or different from each other. The cross-sectional shape of the passages can be uniform, irregular, varying, or any combination thereof, as the passage extends through the structured heat transfer media. In an embodiment, the passages have a uniform cross-sectional shape that is the same as the shape of the perforation on the top surface to which the passage is connected. In another embodiment, the cross-sectional shape of the passages changes as the passage extends through the structured heat transfer media.

In an embodiment, any particular passage connects at least one perforation on the top surface of the structured heat storage media to at least one perforation on the bottom surface of the structured heat transfer media. The path of the passages can be substantially linear, non-torturous, tortuous, or combinations thereof. In an embodiment, the passages are non-tortuous (i.e., substantially straight, substantially linear) through the body of the structured heat transfer media. In another embodiment, one or more of the passages can be tortuous (i.e., irregular, that is, having a shape through the structured heat storage media that includes curves and turns and is, therefore, not straight)

The structured heat storage media can include a mixing cavity-creating element. The function of the mixing cavity-creating element is to create a mixing cavity, or continuous space, between two thermal energy storage blocks (i.e., a first structured heat storage element and a second structured heat transfer element) that separates the opposing surfaces of the thermal energy storage blocks when they are placed adjacent to each other (such as, stacked atop each other or laid end to end). Heat transfer fluid flowing through the various passages of the first structured heat storage media is allowed to comingle, or mix, within the mixing cavity between adjacent blocks, which promotes temperature equalization and reduces the opportunity for any individual portion of the heat transfer fluid to have a temperature significantly above or below the average temperature of other portions of heat transfer fluid passing through the structured heat transfer media, thereby also reducing the opportunity for “hot-spots” to develop.

In an embodiment, the mixing cavity-creating element is integral to the structured heat transfer media. In another embodiment, the mixing cavity-creating element is external to the structured heat transfer media. In an embodiment, an external mixing cavity-creating element is a separate component, such as a spacer ring, that is separate from the structured heat transfer media. In another embodiment, an external mixing cavity-creating element is a component that is part of, or extends from the common container, at least first inner container, or plurality of inner containers in which the structured heat storage media is disposed.

An integral mixing cavity-creating element can be integral to the top surface, the bottom surface, or both the top and bottom surfaces of the structured heat transfer media. For example, as shown in FIG. 4, an integral mixing cavity-creating element can be formed or molded on the top surface, the bottom surface, or both. In an embodiment, an integral mixing cavity-creating element can be a protrusion that extends orthogonally from either or both of the top or bottom surfaces of the structured heat transfer media. In another embodiment, the mixing cavity-creating element can be a plurality of integral protrusions that extend from either or both of the top or bottom surfaces of the structured heat transfer media.

A protrusion can take any shape or form that does not obstruct the perforations on the surface of the structured heat transfer media. A protrusion can be regular or irregular. A protrusion can have a continuous or discontinuous shape. A protrusion can be located anywhere on the top or bottom surface of the structured heat transfer media. In an embodiment, a protrusion can be a raised solid body, such as a polygonal prism, frusta, dome, or combinations thereof. In an embodiment, a protrusion can be a strip, lip, wall, mound, or combinations thereof.

In an embodiment, at least one protrusion can take the form of a strip. In an embodiment, a strip can be straight, curved, winding, angled, or combinations thereof. In an embodiment, a strip can extend between adjacent perforations. In an embodiment, a strip can surround one or more perforations. In an embodiment, one or more strips can intersect.

In an embodiment, the protrusion is a lip that extends radially about the periphery of the top surface of the structured heat transfer media.

FIG. 4 shows an integral element, top surface, continuous lip or wall along periphery of the top surface of a structured heat transfer media.

A protrusion from the top surface of one structured heat storage media can be formed to interlock with, or complement in shape, a protrusion from the bottom surface of an overlying adjacent structured heat transfer media. In an embodiment, a protrusion on the top surface of a structured heat storage media can be in the shape of a semi-circle, while a protrusion on the bottom surface of an overlying adjacent structured heat storage media can have a complimentary shaped semi-circle, such that when one body is placed above the adjacent body, the semi-circles interlock or complement a substantially complete circle.

The height of a mixing cavity-creating element is notable and affects the size of a mixing cavity, or mixing cavities, created between adjacent thermal energy storage bodies. The height of a mixing cavity-creating element is related to the desired height of a mixing cavity, as well as the hydraulic diameter of the perforations on the top or bottom surface of the structured heat transfer media. The height of a singular protrusion, or the sum of multiple protrusions that are stacked upon each other, can define the height of the mixing cavity between adjacent thermal energy storage bodies. However, the height of the mixing cavity, and thus, the total height of any mixing cavity-creating elements, singular or as a sum total, is not greater than the average hydraulic diameter (D_{Havg}) of the perforations on the top surface of the structured heat transfer media, such as not greater than about 0.9 D_{Havg}, not greater than about 0.8 D_{Havg}, not greater than about 0.7 D_{Havg}, or not greater than about 0.6 D_{Havg}. In an embodiment, the total height of any mixing cavity-creating elements, singular or as a sum total, is not less than about 0.1 D_{Havg}, such as not less than about 0.2 D_{Havg}, not less than 0.3 D_{Havg}, or not less than about 0.4 D_{Havg}. The total height of any mixing cavity-creating elements, singular or as a sum total, can be within a range comprising any pair of the previous upper and lower limits. In a particular embodiment, the total height of any mixing cavity-creating elements, singular or as a sum total, can be in a range of about ⅓ to 1 times the D_{Havg} of the perforations on the top surface of the structured heat transfer media.

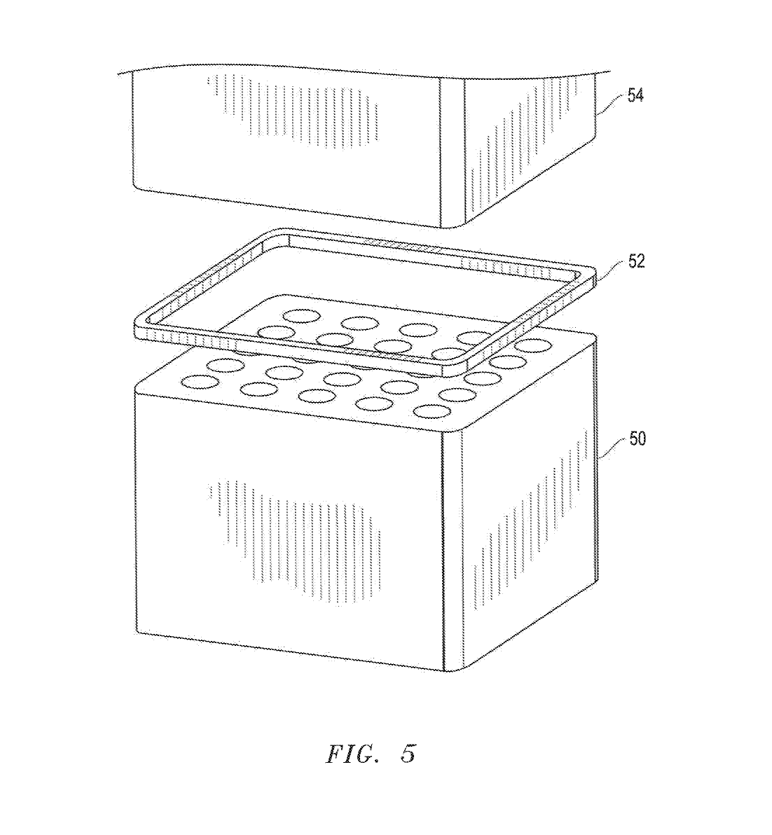

As mentioned previously, a mixing cavity-creating element can be a separable element (i.e., an external element) from the top surface of the structured heat transfer media. In an embodiment, as shown in FIG. 5, an external cavity-creating element can be an annular body, such as an annular ring 52. An annular ring can be a circular ring, a square ring, a polygonal ring, or other shaped ring, such as a shape that matches the perimeter of the top surface of the structured heat storage media 50. In a particular embodiment the annular ring 52 can be a spacer ring, spacer flange, spacer gasket, or the like disposed between a first structured heat storage element 50 and a second structured heat storage element overlying the first structured heat storage element. In an embodiment, the external cavity-creating element can be a single annular body or a plurality of annular bodies disposed overlying each other. As discussed previously above, the mixing cavity can have a height in a range of about ⅓ to 1 times the average hydraulic diameter (D_{Havg}) of the perforations on the top surface of the structured heat transfer media, therefore the total height of an external annular body, or the sum total of multiple annular bodies, will also be in a range of about ⅓ to 1 times the average hydraulic diameter (D_{Havg}) of the perforations on the top surface of the structured heat transfer media.

In another embodiment, an external mixing cavity-creating element can be a protrusion, a body, or a member, such as a support member, that extends from an interior surface of the common container, the at least first inner container, or a plurality of inner containers in which one or more of the thermal energy storage blocks are disposed. In an embodiment, a common container can include a support member, such as a shelf, upon which a structured heat storage media block can rest, the support member separating an upper structured heat storage media block from an adjacent lower structured heat storage media block by a distance that defines the mixing cavity between the thermal energy storage blocks. In a specific embodiment, the support member can be a shelf made of angle iron.

As a heat transfer fluid flows through the structured heat transfer elements, a pressure drop across the plurality of structured heat storage elements (PDrop_{structured}) can be measured. The pressure drop measured at various distances across the plurality of structured heat storage elements (PDrop_{structured}) can be useful to characterize certain features of the structured heat storage media as well as the thermal energy storage zone. In an embodiment, the pressure drop across the plurality of structured heat storage elements will be equal to or less than a pressure drop measured across the plurality of random heat storage media (PDrop_{random}).

The structured heat storage media can be formed from any material that provides sufficient structural strength, has sufficient thermal energy storage capacity, and that is compatible with an intended heat transfer fluid, as well as, any other chemicals, compounds, or other materials that will be in contact with the structured heat transfer media. In an embodiment, the body can be formed from metal material, ceramic material, cermet material, vitreous material, composite material, or combinations thereof. In an embodiment, the metal material can be iron, cast iron, carbon steel, alloy steel, stainless steel, or combinations thereof. In an embodiment, the structured heat storage media can be graphite. In an embodiment, the structured heat storage media can be a ceramic structured heat storage media formed from ceramic materials. In an embodiment, the ceramic material can be one of the group consisting of natural clays, synthetic clays, feldspars, zeolites, cordierites, aluminas, zirconia, silica, aluminosilicates, magnesia, iron oxide, titania, silicon carbide, cements, sillimanite, mullite, magnesite, chrome-magnesite, chrome ore, and mixtures thereof. In an embodiment, the clays can be mixed oxides of alumina and silica and can include materials such as kaolin, ball clay, fire clay, china clay, and the like. In certain embodiments, the clays are high plasticity clays, such as ball clay and fire clay. In a particular embodiment, the clay may have a methylene blue index, (“MBI”), of about 11 to 13 meq/100 gm. The term “feldspars” is used herein to describe silicates of alumina with soda, potash, and lime. Other ceramic materials, such as quartz, zircon sand, feldspathic clay, montmorillonite, nepheline syenite, and the like can also be present in minor amounts. In an embodiment, the ceramic material can include oxides, carbides, nitrides, and mixtures thereof of the following compounds: manganese, silicon, nickel, chromium, molybdenum, cobalt, vanadium, tungsten, iron, aluminum, niobium, titanium, copper, and any combination thereof.

In an embodiment, a composition for forming a structured heat storage media can comprise an iron oxide powder composition comprising the following major ingredients in the given ranges:

Fe₂O₃ about 59 wt % to about 98 wt %
SiO₂ about 6 wt % to about 12 wt %
Al₂O₃ about 2 wt % to about 5 wt %
MgO about 0 wt % to about 2 wt %
CaO about 0 wt % to about 1 wt %
MnO about 0 wt % to about 1 wt %
Moisture about 0 wt % to about 1 wt %

It will be understood that the percentages of the major ingredients can be adjusted and that as the amount of one component is increased, one or more other components can be decreased so that a 100% weight percent composition is maintained. Additionally it will be recognized that the above composition is for the major ingredients and that trace amounts of other compounds can be present.

In an embodiment, a composition for forming a structured heat storage media can comprise a clay composition comprising the following major ingredients in the given ranges:

SiO₂ about 49 wt % to about 81 wt %
Al₂O₃ about 22 wt % to about 38 wt %
Fe₂O₃ about 1 wt % to about 2 wt %
MgO about 0 wt % to about 1 wt %
TiO₂ about 2 wt % to about 3 wt %
K₂O about 0 wt % to about 1 wt %

In an embodiment, a composition for forming a structured heat storage media can comprise final composition comprising the following major ingredients in the given ranges:

Fe₂O₃ about 48 wt % to about 80 wt %
SiO₂ about 19 wt % to about 31 wt %
Al₂O₃ about 6 wt % to about 10 wt %
MgO about 1 wt % to about 1.3 wt %
CaO about 0 wt % to about 1 wt %
MnO about 0 wt % to about 3 wt %
TiO₂ about 0 wt % to about 1 wt %

External mixing cavity-creating components, can be formed from the same materials described above used to form thermal energy storage bodies.

The random heat storage media (also called dumped heat storage media) can be of any type or shape presently known in the art. The random heat storage media is typically small in size and of varying shapes, such as spheres, saddles, short hollow tubes, barrels, rods, rings, wagon wheels, and small cage-like structures.

The thermal energy storage properties of the thermal energy storage zone can be influenced by the void fraction per unit volume of the random heat storage media. The void fraction per unit volume of the random heat storage media can be in a range of not greater than about 38%, such as not greater than about 37%, not greater than about 36%, or not greater than about 35%. In an embodiment, the void volume of the random heat storage media can be in a range of not less than about 7%, such as not less than about 8%, not less than about 9%, or not less than about 10%. The void volume of the random heat storage media can be within a range comprising any pair of the previous upper and lower limits. In a particular embodiment, the void volume of the random heat storage media can be in a range of not less than about 10% to not greater than about 35%.

As a heat transfer fluid flows through the random heat storage elements, a pressure drop across the plurality of the random heat storage elements (PDrop_{random}) can be measured. The pressure drop measured at various distances across the plurality of random heat storage elements (PDrop_{random}) can be useful to characterize certain features of the random heat storage media as well as the thermal energy storage zone. In an embodiment, the pressure drop across the plurality of random heat storage elements is equal to or greater than a pressure drop measured across the plurality of structured heat storage media (PDrop_{structured}).

Random heat storage media can be formed from the same materials described above used to form thermal energy storage bodies.

The pressure drop measured at various distances across the plurality of the structured heat storage elements (PDrop_{structured}) and the random heat storage elements (PDrop_{random}) can be useful to characterize certain features of the thermal energy storage zone. In an embodiment, a pressure drop measured across the plurality of random heat storage media (PDrop_{random}) and a pressure drop measured across the plurality of structured heat storage elements (PDrop_{structured}) have a percent difference of 25% or less. In another embodiment, a pressure drop measured across the plurality of random heat storage media (PDrop_{random}) is greater than or equal to a pressure drop measured across the plurality of structured heat storage elements (PDrop_{structured}). In another embodiment, a pressure drop measured across the plurality of random heat storage media (PDrop_{random}) and a pressure drop measured across the plurality of structured heat storage elements (PDrop_{structured}) is such that the ratio of PDrop_{random} to PDrop_{structured} is in a range from about 10:1 to about 1:1.

The void fraction of the structured heat storage elements (Vfₛ) and the void fraction per unit volume of the random heat storage elements (Vfᵣ) can be useful to characterize certain features of the thermal energy storage zone. In an embodiment, the plurality of the structured heat storage elements can have a void fraction Vfₛ and the plurality of random heat storage media can have void fraction per unit volume Vfᵣ, such that the ratio of Vfᵣ to Vfₛ is in a range from 2:1 to 1:1.

The thermal energy storage zone can further comprise a heat transfer fluid. The heat transfer fluids included will be determined based on the particular application and operating conditions of the heat collection and storage system under consideration. The heat transfer fluid can be a gas, a liquid, or combinations thereof. The heat transfer fluid can be aqueous, organic, or combinations thereof. The type of heat transfer fluid can be varied within certain regions of the thermal energy storage zone if desired, such a through certain types of media or along particular pluralities of flow paths. In an embodiment, the heat transfer fluid will be an organic liquid, such as an oil. In a particular embodiment, the oil can be a mineral oil, such as a mixture of paraffins and napthenes, high purity white mineral oil, mixtures of diphenyl-oxide and biphenyl, mixtures of diphenyl oxide and 1,1-diphenylethane, a modified terphenyl, any combinations thereof, and the like.

A thermal energy storage zone comprises: an outer container; a plurality of structured heat transfer elements; and a plurality of random media, wherein the structured heat storage elements and the plurality of random heat storage media are disposed within the outer container. As described above, the outer container is synonymous with the outer container described above. The structured media can have the properties previously described above. The random heat storage media can have the properties previously described above. In a particular embodiment, the thermal energy storage zone comprises a large tank, vertical or horizontal, without any inner containers being disposed therein, having an inlet and an outlet for the flow of heat transfer fluid, and that has structured thermal energy storage media and random thermal energy storage media disposed within the large tank.

A thermal energy storage zone can further comprise at least a first inner container; wherein the at least first inner container is disposed within the outer container, and wherein the plurality of structured heat storage elements are disposed within the at least first inner container, and wherein the plurality of random heat storage media are disposed within the outer container and outside of the at least first inner container. The outer container can have the properties previously described above. The structured heat storage media can have the properties previously described above. The random heat storage media can have the properties previously described above.

In a particular embodiment, the thermal energy storage zone comprises a large tank having at least one inner container, such as a tube or sleeve, disposed within the large tank, wherein structured thermal energy storage media is disposed within the at least one inner container and random thermal energy storage media is disposed within the large tank but outside the inner container, such as at least a portion of the space between the interior surface of the large tank and the outside of the at least one inner container.

In another embodiment, the thermal energy storage zone can comprise a plurality of inner containers disposed within the outer container, wherein a plurality of structured heat storage elements are disposed within the plurality of inner containers, and wherein a plurality of random heat storage media are disposed within the outer container and outside of the plurality of inner containers. The random heat storage media can be disposed between, among, or around the plurality of inner containers, or combinations thereof. The structured heat storage elements can have the same properties as described above. The random heat storage media heat transfer elements can have the same properties as described above.

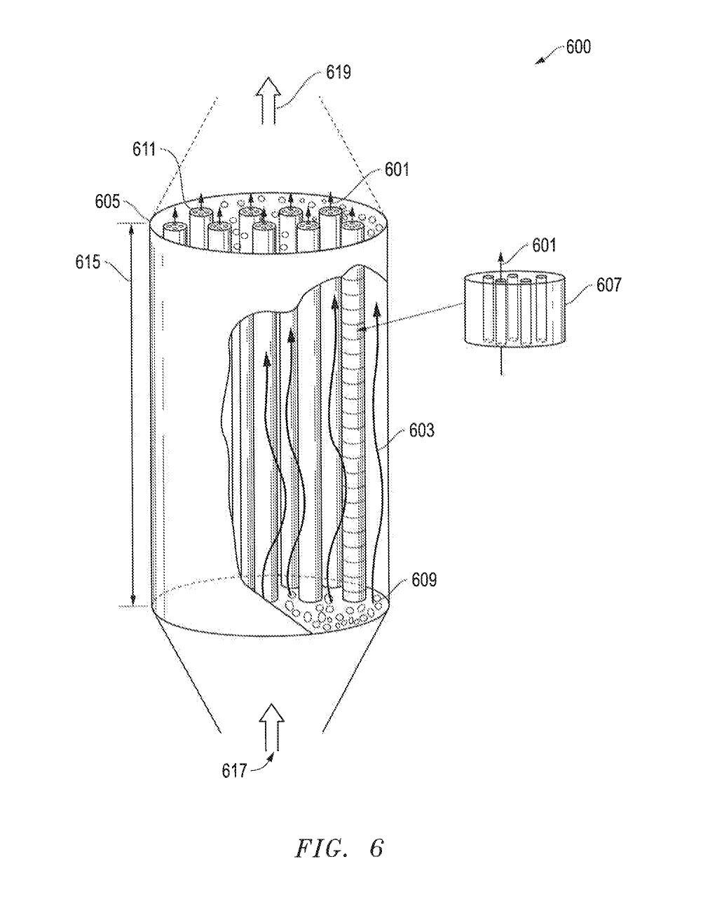

In a particular embodiment, as shown in FIG. 6, a thermal energy storage zone 600 comprises a first plurality of flow paths 601 and a second plurality of flow paths 603, wherein the first and second plurality of flow paths pass through a common container 605 in the form of a large tank. A plurality of inner containers 611, such as tubes, are disposed in a regular pattern within the large tank. Structured thermal energy storage media 607 is disposed within the plurality of inner containers and random thermal energy storage media 609 is disposed within the large tank but outside of the plurality of inner containers, such as in at least a portion of the space between the interior surface of the large tank and the outside of the plurality of inner containers. The first plurality of flow paths are configured to extend through the plurality of structured heat storage elements 607 and the second plurality of flow paths are configured to extend through the plurality of random heat storage media 609. The structured heat storage elements and the random heat storage media form a bed. The container can be filed with random heat storage media up to the same height as the structured heat transfer elements. The height 615 of the structured heat transfer elements defines the height of the thermal energy storage zone. The first plurality of flow paths and the second plurality of flow paths do not intersect within the bed of thermal energy storage media. The first plurality of flow paths are substantially linear and the second plurality of flow paths are tortuous. The first plurality of flow paths and the second plurality of flow paths share a common inlet 617 region into the bed of thermal heat storage media and a common outlet 619 region out of the bed of thermal heat storage media.

A thermal energy storage zone can be constructed by stacking structured heat storage elements inside an outer container and then surrounding the stacked structured heat storage elements with random heat storage media.

In a first embodiment, a thermal energy storage zone is constructed by disposing structured heat storage elements within an outer container. Any space between the interior surface of the outer container and the structured heat storage elements can be left empty, or instead filled with an insulation material, or random heat storage media, or a combination thereof. If desired, baffle plates or the like can be positioned at the bottom and top of the stack of structured heat storage elements to guide the flow of heat transfer fluid into the structured heat transfer elements. In another embodiment, the structured heat storage elements can be packed into one or more inner containers, such as pipes or tubes that are disposed within the outer container. The inner containers can be packed with structured heat storage elements prior to being disposed within the outer container. The ability to prepack the inner containers with structured heat storage elements provides greater construction efficiency and flexibility by allowing portions of the thermal energy storage zone to be constructed off-site and then transported to the location where the thermal energy storage zone will be located.

### Example 1a

### Structured Thermal Energy Storage Block—Cylindrical

Theoretical calculations are presented for a structured thermal energy storage element (structured thermal energy storage block) that is cylindrical. The block can have 55 perforations with straight passages through the body of the block that are arranged in a radial pattern. The open face area and the void fraction of the block can both be 0.35 (35%). The block can have a diameter of 0.15 m (6 inches) and a length of 0.15 m (6 inches).

The “open area” of the top of the block is about 69.29 sq. cm (10.74 sq. in.) The average hydraulic diameter D_{H} of the perforations of the top face will be about 0.013 m (0.5 inches).

### Example 1b

### Thermal Heat Storage Unit—Rectangular

Theoretical calculations are presented for a structured thermal energy storage element (structured thermal energy storage block) that has a rectangular prism shape. The block can have 25 circular perforations with straight passages through the block that are arranged in a uniform array of 5 rows of 5 perforations per row (a 5×5 pattern). The block will have a void fraction of 0.20 (20%) and an open face area of 0.20 (20%). The block will have a length of 0.15 m (6 inches), a width of 0.15 m (6 inches), and a length of 0.2 m (8 inches). The ratio of hydraulic diameter to wall thickness (D_{H}/Thk) is 1.33. The spacing of the perforations is 2232 to 2335 holes per square meter (1.44 to 1.5 holes per square inch).

The “open area” of the top face of the block is about 46.45 cm² (7.2 in²). The average hydraulic diameter D_{H} of the perforations of the top face will be about 1.86 cm² (0.288 in²). The average hole diameter will be about 1.5 cm (0.6 inches). The average minimum wall thickness will be about 1.14 cm (0.45 inches). The ratio of hydraulic diameter to wail thickness (D_{H}/Thk) will be about 1.33.

### Example 1c

The blocks of example 1a and 1b can be composed of a ceramic material having a composition as shown in the table below.

TABLE 1

| Major Ingredients | Weight % |
|---|---|
| Fe₂O₃ | 64.0% |
| SiO₂ | 24.8% |
| Al₂O₃ | 8.0% |
| MgO | 1.0% |
| CaO | 0.5% |
| MnO | 0.4% |
| TiO₂ | 0.5% |

### Example 2

### Thermal Energy Storage Zone: Single Round Outer Container, Rectangular Blocks within, No Separate Inner Containers

A thermal energy storage zone can be constructed by filling a tank with structured heat storage media surrounded by random heat storage media. The tank can be cylindrical and have a working volume of approximately 1,500 m³ (396,258 gallons), a diameter of 68.58 m (225 ft.) and a height of 45.72 m (150 ft). The tank can have an appropriate amount of clearance space, i.e., “head space”, both above and below the working volume. The tank can be constructed of steel.

The structured heat storage media can be modular and have the shape of rectangular prisms (“rectangular blocks”) with dimensions that are approximately 0.15 m (0.5 ft.) long by 0.15 m (0.5 ft.) wide by 0.3 m (1 foot) high. Each of the structured heat storage media can have an open face area in a range of approximately 15% to 38% and a void fraction of approximately 15% to 38%. Each of the structured heat storage media can have passages that extend vertically through the body of the structured heat transfer media. The ceramic structured heat storage media can be molded so that when two blocks are stacked atop one another they fit together end-to-end and have a built-in enclosed cavity located between the blocks. The flow paths through such stacked blocks will be substantially vertical and substantially linear through each block. The flow paths through a vertical stack of blocks will be separate from an adjacent vertical stack of blocks. The flow paths through a vertical stack of blocks can merge within the built-in enclosed cavity located between the blocks and then re-branch into separate flow paths through the body of the next block. The structured heat storage media blocks can be stacked up atop each other and in layers to form a large rectangular prism having a square shaped base that is centered within the cylindrical tank. The height of the stacked structured media will be equal to the height of the working volume. The structured heat storage media can be made of a ceramic material.

The gap space between the side of the stack of structured media and the internal wall of the steel tank can be filled with random heat storage media. The random heat storage media can be small spheres, saddles, tubes, wheels, rings, barrels, rods, or combinations thereof. The random heat storage media can be poured into the gap space and filled up to a height equal to the height of the structured heat transfer media. The random heat storage media is sized such that the bed, or beds, of random heat storage media will have a pressure drop measured across the bed that is equal to the pressure drop measured across the structured heat transfer media. The flow paths through the bed of random heat storage media will be tortuous. The random heat storage media can be made of the same ceramic material as the structured heat transfer media.

A hot heat transfer fluid can flow into the tank through an inlet and through the structured heat storage media and the random heat storage media. The heat transfer fluid can transfer heat to the structured heat storage media and the random heat storage media wherein the heat is stored in the structured heat storage media and the random heat storage media until it is needed. The heat transfer fluid can flow out of the tank through an outlet.

The thermal energy stored in the structured heat storage media and the random heat storage media can be withdrawn as needed by flowing cool heat transfer fluid back through the structured heat storage media and the random heat storage media.

### Example 3

### Thermal Energy Zone—Outer Container & Single Inner Container

A thermal energy storage zone can be constructed by filling a tank (i.e., an outer container) with structured heat storage media that is disposed within an inner container. The inner container is disposed within the tank and the inner container is surrounded by random heat storage media. The tank can be cylindrical and have a working volume and other properties the same as in example 2.

The structured heat storage media can be modular and have the same shape, dimensions, and other properties above as in example 2. Again, the structured heat storage media can be stacked atop each other to form a large rectangular prism having a square shaped base that is centered within the cylindrical tank; however, unlike example 2, the structured heat storage media can be stacked within a second container, which can have interior dimensions to fit the desired shape of the stack of the structured heat transfer media. The height of the second container will be equal to the height of the stacked structured media. The second container can be made of steel.

The second container can be pre-packed with the structured heat storage media offsite and transported to the site where the thermal energy storage zone is to be constructed. The pre-packed second container can be placed within the tank by the use of suitable construction equipment. Random heat storage media having the same properties as in example 2 can then be poured into the gap space between the inner surface of the tank and the outer surface of the second container. The pressure drop across the bed, or beds, of random heat storage media will be the same as the pressure drop across the structured heat transfer media.

Heat transfer fluid can be introduced and circulated through the structured heat storage media and random heat storage media as described in example 2.

### Example 4

### Thermal Energy Zone—Outer Container and Plurality of Inner Containers

A thermal energy storage zone can be constructed by filling a tank (i.e., the outer container) with structured heat storage media that is disposed within an array of tubes (i.e., inner containers) that are disposed within the tank and that are surrounded by random heat storage media. The tank can be cylindrical and have a working volume and other properties the same as in example 2.

The structured heat storage media can be modular and have the shape of cylinders (“cylindrical blocks”) with dimensions that are approximately 0.15 m (0.5 ft.) in diameter by 0.3 m (1 foot) high. Each of the structured heat storage media can have an open face area, a void fraction, and passages that extend vertically through the body of the structured heat storage media as in example 2. Unlike example 2, the structured heat storage media can be stacked within a plurality of tubes, each of which said tubes have an interior diameter that matches the diameter of a single cylindrical block of structured heat transfer media. Also, unlike example 2, a spacer element, such as a spacer ring, can be placed within the tube between two stacked blocks in order to create a cavity between the stacked blocks. The flow path through the stacked blocks disposed within the inner containers will be substantially vertical and substantially linear through each block. The flow paths through a vertical stack of blocks can merge within the cavity located between the blocks and then re-branch into separate flow paths through the body of the next block. The plurality of inner containers can be arranged in a radial pattern that is equally distributed about the interior of the tank. The height of each inner container will be equal to the height of the stacked structured heat transfer media. The inner containers can be made of steel.

Similar to example 3, the plurality of inner containers can be pre-packed with the structured heat storage media offsite and then transported to the site where the thermal energy storage zone is to be constructed. The pre-packed inner containers can be placed within the tank by the use of suitable construction equipment. Random heat storage media having the same properties as in example 1 can then be poured into the space between and around the inner containers, including in the gap space between the inner surface of the tank and the outer surface of the inner containers. The pressure drop across the bed, or beds, of random heat storage media will be the same as the pressure drop across the structured heat transfer media.

Heat transfer fluid can be introduced and circulated through the structured heat storage media and random heat storage media as described in example 2.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A thermal energy storage zone comprising:
a first plurality of flow paths;
a second plurality of flow paths; and
a bed of heat storage media comprising a plurality of structured heat storage elements and a plurality of random heat storage media,
wherein the first and second plurality of flow paths pass through a common container,
wherein the first plurality of flow paths are configured to extend through the plurality of structured heat storage elements and the second plurality of flow paths are configured to extend through the random heat storage media, and
wherein the first plurality of flow paths and the second plurality of flow paths do not intersect within the bed of heat storage media.

2. The thermal energy storage zone of claim 1, wherein the first plurality of flow paths are substantially linear.

3. The thermal energy storage zone of claim 1, wherein the second plurality of flow paths are tortuous.

4. The thermal energy storage zone of claim 1, wherein the first plurality of flow paths periodically merge into a single flow path that later rebranches into a plurality of flow paths.

5. The thermal energy storage zone of claim 1, wherein the first plurality of flow paths is separated from the second plurality of flow paths by a continuous wall.

6. The thermal energy storage zone of claim 1, wherein the first plurality of flow paths pass through at least a first inner container disposed within the common container.

7. The thermal energy storage zone of claim 1, wherein the first plurality of flow paths pass through a plurality of inner containers disposed within the common container.

8. The thermal energy storage zone of claim 1, wherein the first and second plurality of flow paths share a common inlet region and a common outlet region.

9. The thermal energy storage zone of claim 1, further comprising a thermal energy transfer fluid.

10. The thermal energy storage zone of claim 1, wherein a pressure drop measured across the first plurality of flow paths (PDrop1) and a pressure drop measured across the second plurality of flow paths (PDrop2) is such that the ratio of PDrop1 to PDrop2 is in a range from 0.7:1 to 1:1.

11. The thermal energy storage zone of claim 1, wherein fluid flow through the first plurality of flow paths is laminar or turbulent and fluid flow through the second plurality of flow paths is laminar or turbulent.

12. A thermal energy storage zone comprising:
an outer container;
a plurality of structured heat transfer elements; and
a plurality of random media,
wherein the plurality of structured heat storage elements and the plurality of random heat storage media are disposed within the outer container, and.
wherein the plurality of structured heat storage elements and the plurality of random heat storage media are in substantially parallel alignment to each other.

13. The thermal energy storage zone of claim 12, wherein the plurality of structured heat storage elements and the plurality of random heat storage media are substantially aligned with the direction of the flow of a fluid through the thermal energy storage zone.

14. The thermal energy storage zone of claim 12, further comprising:
an at least second container;
wherein the at least first inner container is disposed within the outer container,
wherein the plurality of structured heat storage elements are disposed within the at least first inner container, and
wherein the plurality of random heat storage media are disposed within the outer container and outside of the at least first inner container.

15. The thermal energy storage zone of claim 12, further comprising a plurality of inner containers disposed within the outer container,
wherein the plurality of structured heat storage elements are disposed within the plurality of inner containers, and
wherein a the plurality of random heat storage media are disposed within the outer container and outside of the plurality of inner containers.

16. The thermal energy storage zone of claim 15, wherein the random heat storage media is disposed between the plurality of inner containers.

17. The thermal energy storage zone of claim 12, wherein a pressure drop measured across the plurality of random heat storage media (PDroprandom) and a pressure drop measured across the plurality of structured heat storage elements (PDropstructured) have a percent difference of 25% or less.

18. The thermal energy storage zone of claim 12, wherein a pressure drop measured across the plurality of random heat storage media (PDroprandom) is greater than or equal to a pressure drop measured across the plurality of structured heat storage elements (PDropstructured).

19. The thermal energy storage zone of claim 12, wherein a pressure drop measured across the plurality of random heat storage media (PDroprandom) and a pressure drop measured across the plurality of structured heat storage elements (PDropstructured) is such that the ratio of PDroprandom to PDropstructured is in a range from about 10:1 to about 1:1.

20. The thermal energy storage zone of claim 12, further comprising an open cavity disposed between at least two of the plurality of structured heat transfer elements.

21. The thermal energy storage zone of claim 12, wherein the total height of the structured heat storage elements defines the height of the thermal energy storage zone.

22. The thermal energy storage zone of claim 12, wherein the height of the thermal energy storage zone is at least 50% of the height of the outer container.

23. The thermal energy storage zone of claim 12, wherein the plurality of the structured heat storage elements has a void fraction Vfₛ and the plurality of random heat storage media has a unit volume void fraction Vfᵣ, such that the ratio of Vfᵣ to Vfₛ is in a range from 2:1 to 1:1.

24. The thermal energy storage zone of claim 12, wherein each of the plurality of structured heat storage elements has a void fraction of 38% or less.

25. The thermal energy storage zone of claim 12, wherein the plurality of structured heat storage elements are configured to conform to the inner dimensions of the outer container.

26. The thermal energy storage zone of claim 14, wherein the plurality of structured heat storage elements are configured to conform to the inner dimension of the at least first inner container.

27. The thermal energy storage zone of claim 15, wherein the plurality of structured heat storage elements are configured to conform to the inner dimensions of each of the plurality of inner containers.

28. The thermal energy storage zone of claim 12, wherein the plurality of structured heat storage elements are arranged vertically within the outer container.

29. The thermal energy storage zone of claim 14, wherein the plurality of structured heat storage elements are arranged vertically within the at least first inner container.

30. The thermal energy storage zone of claim 15, wherein at least two of the plurality of structured heat storage elements are arranged vertically within each of the plurality of inner containers.

31. The thermal energy storage zone of claim 12, wherein at least two of the plurality of structured heat storage elements are arranged horizontally within the outer container.

32. The thermal energy storage zone of claim 14, wherein at least two of the plurality of structured heat storage elements are arranged horizontally within the at least 2nd container.

33. The thermal energy storage zone of claim 15, wherein at least two of the plurality of structured heat storage elements are arranged horizontally each of the plurality of inner containers.

34. The thermal energy storage zone of claim 12 or claim 14, wherein at least two of the structured heat storage elements are comprised of a ceramic material.

35. The thermal energy storage zone of claim 12, wherein the random heat storage media has a void fraction per unit volume in a range of 15% to 38%.

36. The thermal energy storage zone of claim 12, wherein the random heat storage media is disposed between an inner surface of the outer container and the structured heat transfer elements.

37. The thermal energy storage zone of claim 14, wherein the random heat storage media is disposed between an inner surface of the outer container and an outer surface of the at least first inner container.

38. The thermal energy storage zone of claim 15, wherein the random heat storage media is disposed between an inner surface of the outer container and an outer surface of each of the plurality of inner containers.

39. The thermal energy storage zone of claim 15, wherein the random heat storage media is arranged around the inner containers.

40. The thermal energy storage zone of claim 14, wherein the random heat storage media is comprised of the same or different materials of construction as the structured heat transfer elements.

41. The thermal energy storage zone of claim 12, wherein the outer container has an inlet and an outlet.

42. The thermal energy storage zone of claim 14, wherein the outer container is configured to hold the at least first inner container in an orientation selected from the group consisting of: horizontal, vertical, or slanted.

43. The thermal energy storage zone of claim 15, wherein the outer container is configured to hold the plurality of inner containers in an orientation selected from the group consisting of: horizontal, vertical, slanted, or combinations thereof.

44. The thermal energy storage zone of claim 12, wherein the outer container is one of the group consisting of: a tank, a pipe, a reactor, a column, a tower, and the like.

45. The thermal energy storage zone of claim 14, wherein the at least first inner container has an inlet and an outlet.

46. The thermal energy storage zone of claim 15, wherein each of the plurality of inner containers have an inlet and an outlet.

47. The thermal energy storage zone of claim 14, wherein the at least first inner container has a height equal to from about 50% to about 150% of the total height of the plurality of structured heat transfer elements.

48. The thermal energy storage zone of claim 15, wherein each of the plurality of inner containers has a height equal to from about 50% to about 150% of the total height of the plurality of structured heat transfer elements.

49. The thermal energy storage zone of claim 15, wherein the plurality of inner containers is arranged in a pattern within the outer container.

50. The thermal energy storage zone of claim 14, wherein the at least first inner containers is a tube.

51. The thermal energy storage zone of claim 15, wherein the plurality of inner containers have a cross-sectional shape selected from one of the group consisting of: circular, triangular, quadrilateral, pentagonal, hexagonal, heptagonal, octagonal, and combinations thereof.
